(19) United States
(12) Patent Application Publication
(10) Pub. No.: US 2024/0218724 A1
(43) Pub. Date: Jul. 4, 2024

(54) MOTOR-TYPE MULTI-HINGE

(71) Applicant: SEO WON KOREA CO., LTD, Gimhae-si (KR)

(72) Inventors: June Young LEE, Busan (KR); Sang Baek KIM, Gimhae-si (KR); Kyoung Rok KIM, Busan (KR)

(21) Appl. No.: 18/610,038

(22) Filed: Mar. 19, 2024

Related U.S. Application Data
(63) Continuation of application No. PCT/KR2022/004876, filed on Apr. 5, 2022.

(30) Foreign Application Priority Data
Nov. 15, 2021 (KR) 10-2021-0156551

(51) Int. Cl. E05F 15/63; F24C 15/02

(52) U.S. Cl. CPC E05F 15/63; F24C 15/023; E05Y 2201/624; E05Y 2201/686; E05Y 2900/308

(57) ABSTRACT

The present invention relates to a motor-type multi-hinge and, more particularly, to a motor-type multi-hinge that, when the door is opened, is opened while being pushed downward from a main body such that a sufficient space can be secured in an oven equipped with a water container so as to facilitate replacement of the water container.

### REFERENCE TO RELATED APPLICATIONS

This is a continuation of International Patent Application PCT/KR2022/004876 filed on Apr. 5, 2022, which designates the United States and claims priority of Korean Patent Application No. 10-2021-0156551 filed on Nov. 15, 2021, the entire contents of which are incorporated herein by reference.

### FIELD OF THE INVENTION

The present disclosure relates to a motor-type multi-hinge and, more particularly, to a motor-type multi-hinge, wherein when a door is opened, the motor-type multi-hinge allows the door to be opened while being pushed downward from a main body to make a usable space wide.

### BACKGROUND OF THE INVENTION

In general, an oven (oven range) is an apparatus that heats and cooks food to be cooked after the food is inserted into a cooking space and a door is closed to seal the cooking space.

The oven includes a water container for performing a steaming operation. The water container is usually provided at an upper portion of the oven, a display provided at the upper portion of the oven is used as a door, and the water container is provided at an upper portion of a main body coupled to the display with a hinge.

The oven, and the hinge coupling state between the door and the main body are shown in FIGS. 1A and 1B. FIGS. 1A and 1B are views showing an opened and closed state of an oven door with a uni-axial hinge according to the related art.

Referring to FIGS. 1A and 1B, in a conventional oven, a display 215 used as a door is connected to a main body 211 through a hinge, for example, a uni-axial hinge 200. At this point, the display 215 has a structure that can be opened and closed upward and downward on the basis of an upper end thereof, and the hinge 200 is provided between a lower portion of a display 215 and the main body 211.

Meanwhile, the water container provided in the oven needs to be frequently inserted and removed to supply water thereto. As shown in part A in FIG. 1B, the hinge 200 provided between the lower portion of the display 215 and the main body 211 constrict a usable space, resulting a problem of difficulty of inserting and removing the water container.

In other words, even when the display 215 is opened, an opening 265 provided at an upper portion of the main body 211 to insert and remove the water container is blocked by the display 215.

As described above, since an overlapped portion is generated between the lower portion of the display 215 and the main body 211 due to the hinge 200, even when the display 215 is opened, a usable space is small, and there is a problem in that it is not easy to apply the conventional hinge 200 to home appliance having various spatial limits.

In addition, in order to solve these problems, in order to increase space usability, the space in which the water container is removed and inserted should be made wide, thus increasing the size of the oven increases.

### SUMMARY OF THE INVENTION

Accordingly, the present disclosure has been made keeping in mind the above problems occurring in the related art, and the present disclosure is intended to provide a motor-type multi-hinge, wherein when a door is opened, the motor-type multi-hinge allows the door to be opened while being pushed downward from a main body to make a usable space wide.

Another objective of the present disclosure is to provide a motor-type multi-hinge capable of allowing an oven equipped with a water container to secure sufficient space to facilitate replacement of the water container.

Yet another objective of the present disclosure is to provide a motor-type multi-hinge capable of opening and closing a door smoothly and easily.

In addition, other objectives and advantages of the present disclosure will be described below, and it may be encompassed in a broader scope by means and combinations within the scope that can be easily derived from the disclosure of the matters and embodiments described in the claims of the present disclosure.

In order to achieve the above objectives, according to one aspect of the present disclosure, there is provided a motor-type multi-hinge for a door, and the motor-type multi-hinge includes: a housing provided at a main body of a device equipped with a door; an arm provided at the door; a motor provided at a lower portion of the housing; a first link unit provided inside the housing, and comprising a motor link having a first end rotatably connected to the motor, a hold link having a first end rotatably connected to a second end of the motor link, and a main link having a first end rotatably connected to a second end of the hold link and a second end rotatably connected to a hinge shaft of the arm; and a second link unit provided inside the housing, and comprising a joint link having a first end rotatably connected to the lower portion of the housing, the joint link being rotatably connected to the main link between the first end and a second end thereof, and an upper link having a first end rotatably connected to the second end of the joint link and a second end rotatably connected to a link shaft of the arm, wherein, when the motor is driven, the motor link is rotated and the hold link and the main link are rotated, and the joint link and the upper link are rotated due to rotation of the main link, so that the arm is rotated while being pushed from the housing.

Furthermore, according to a preferred embodiment of the present disclosure, the second link unit may further include a sub link provided inside the housing and between the motor and the joint link, having a first end rotatably connected to the lower portion of the housing and a second end rotatably connected to the main link.

Furthermore, according to a preferred embodiment of the present disclosure, the main link may have a shape bent upward at a predetermined angle, and the main link may be connected to the joint link at the bent portion.

As described above, the present disclosure can have the following effects.

When the door is opened, the door is opened while being pushed from the main body to make a usable space wide. Accordingly, in the oven equipped with the water container, there is the effect of securing sufficient space to facilitate replacement of the water container.

In other words, since the door is opened while being pushed downward, an overlapped portion between the door and the main body is significantly reduced, and the opening provided for replacement of the water container is fully opened. Accordingly, there is the effect of preventing the water container from hitting the door when the water container is replaced.

In addition, the housing and the arm are connected to each other with two shafts, and the multi-hinge structure with engaged multiple links inside the housing is provided, so that there is the effect of opening and closing the door smoothly.

In addition, other effects of the present disclosure can be broader by not only the embodiments described above and disclosure in the claims of the present disclosure, but also by effects that can occur within the scope that can be easily followed from the embodiments and the accompanying claims and by possibilities of potential advantages contributing to industrial development.

### BRIEF DESCRIPTION OF THE DRAWINGS

FIGS. 1A and 1B are views showing a door opened and closed state of an oven with a uni-axial hinge according to the related art.

FIGS. 2A and 2B are views showing a door opened and closed state of a motor-type multi-hinge the present disclosure.

FIGS. 3A and 3B are a sectional view and an exploded perspective view showing the motor-type multi-hinge according to the present disclosure.

FIGS. 4A and 4B are sectional views showing operational states of the motor-type multi-hinge according to the present disclosure.

### DETAILED DESCRIPTION OF THE INVENTION

Hereinbelow, a preferred embodiment of the present disclosure will be described in detail with reference to the accompanying drawings. Prior to the description, advantages and features of the present disclosure and methods for achieving them will be more clearly understood from the following detailed embodiments with reference to the accompanying drawings. The terminology used herein is for the purpose of describing particular embodiments only and is not intended to be limiting of the present disclosure. As used herein, the singular forms are intended to include the plural forms as well, unless the context clearly indicates otherwise. A word indicating a direction is provided for the understanding of the description and may be changed on the basis of a viewpoint.

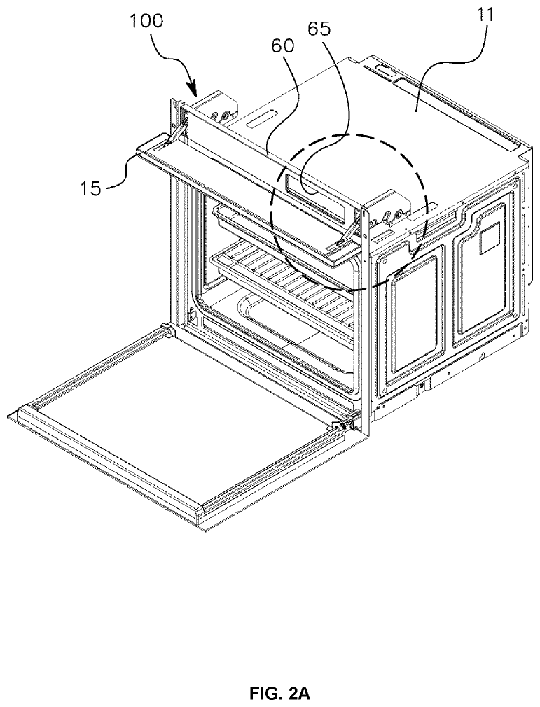

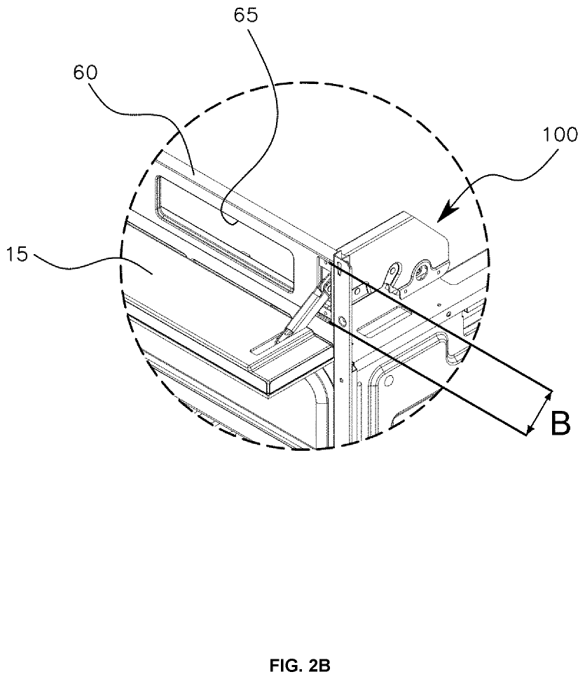

Hereinbelow, a motor-type multi-hinge device according to a preferred embodiment of the present disclosure will be described in detail with reference to the accompanying drawings. FIGS. 2A and 2B are views showing a door opened and closed state of a motor-type multi-hinge the present disclosure.

First, referring to FIGS. 2A and 2B, a motor-type multi-hinge 100 according to the present disclosure is provided at an oven, and as described above, a display is a door 15, and the door is connected to a main body 11 through the motor-type multi-hinge 100 according to the present disclosure.

At this point, the reason why the display should be opened and closed like the door 15 is because a water container (not shown) is provided at an upper portion of the oven and an opening 65 for removing and retracting the water container to supply water into the water container is exposed when opening a display 15, as shown in FIG. 2A.

As described above, when the door 15 is opened through the motor-type multi-hinge 100 according to the present disclosure, due to multi-axial connection and a plurality of links, the door 15 is rotated while being pushed downward from the main body 11 as shown in FIG. 2B. Accordingly, as shown in a part marked with B, the present disclosure has the effect of making the internal space of the oven wider than the structure to which the hinge according to the related art is applied.

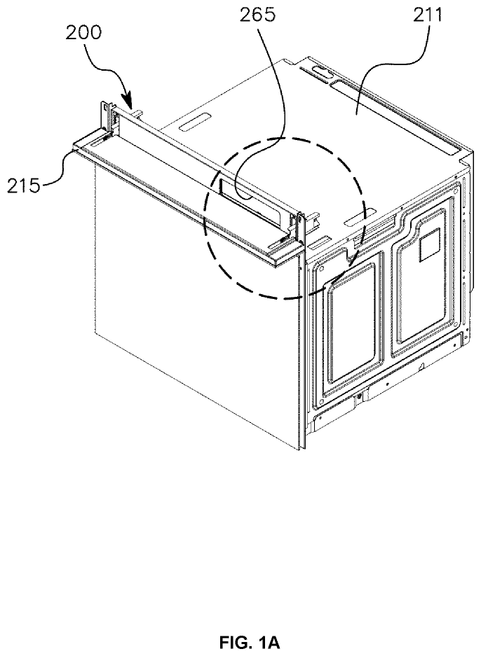

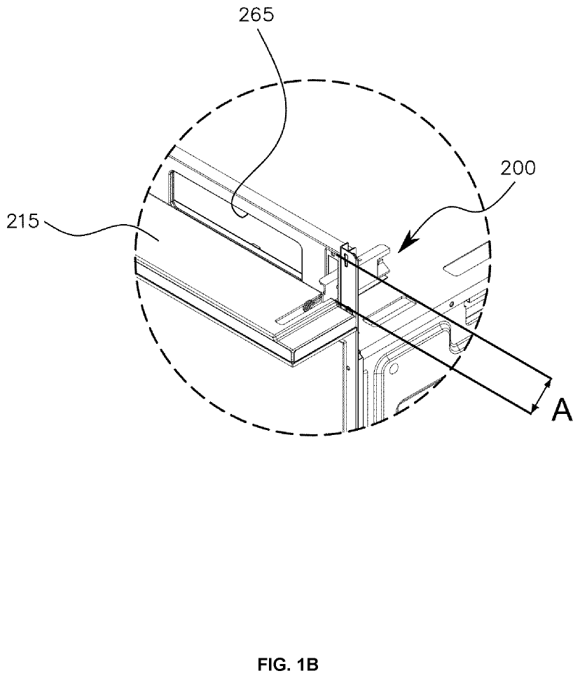

In other words, as shown in a part marked with A in FIG. 1B, in conventional, a usable space is 50.5 mm. However, as shown in the part B marked with FIG. 2B, when the motor-type multi-hinge 100 according to the present disclosure is used, a usable space is 60.8 mm, and the present disclosure has the effect of increasing space usability by 10 mm or more.

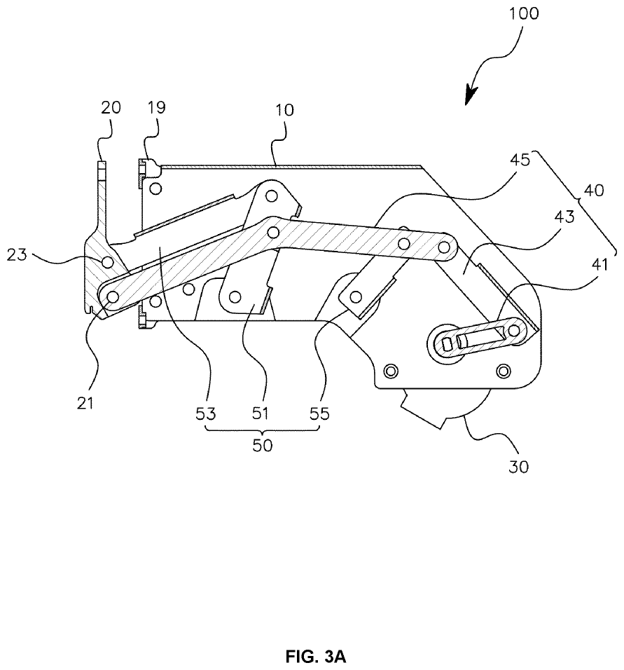

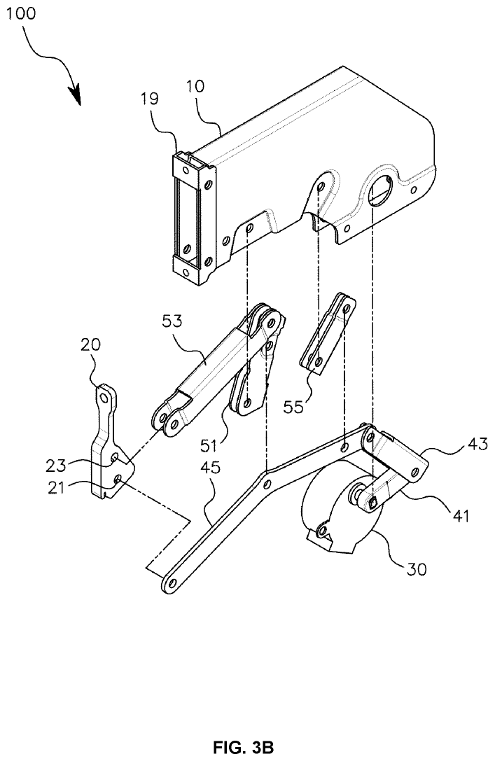

The structure of the motor-type multi-hinge 100 according to the present disclosure will be described in detail with reference to FIGS. 3A and 3B. FIGS. 3A and 3B are a sectional view and an exploded perspective view showing the motor-type multi-hinge according to the present disclosure.

Referring to FIGS. 3A and 3B, the motor-type multi-hinge 100 according to the present disclosure includes a housing 10, an arm 20, a motor 30, a first link unit 40, and a second link unit 50.

First, the housing 10 is provided at the device having the door 15, for example, at the main body 11 of the oven having the display 15, and may be fixedly installed at the opposite portions of the main body 11 of the oven.

In other words, as shown in FIG. 2A, a first lower portion of the housing 10 is fixedly installed at an upper portion of the main body 11, and a bracket 20 provided at a second portion of the housing 10 is fixedly installed at a support part 60 between the door 15 and the main body 11.

At this point, the support part 60 is provided between the door 15 and the main body 11, and extends upward from the main body 11 to support the door 15, and supports the motor-type multi-hinge 100 according to the present disclosure, and has the opening 65 through which the water container provided above the main body 11 is removed and retracted.

Next, the arm 20 is installed at the display, i.e., at the door 15, and when the door 15 is opened and closed, the arm 20 is rotated together with the door 15.

This arm 20 includes a hinge shaft 21 and a link shaft 23. Unlike a conventional hinge that is a uni-axial hinge with a single hinge shaft, the arm 20 of the motor-type multi-hinge 100 according to the present disclosure is characterized to be a multi-axial hinge, i.e., a multi-hinge, including the hinge shaft 21 and the link shaft 23. Accordingly, the door 15 maybe rotated while being pushed downward.

Next, the motor 30 is provided at a first lower portion inside the housing 10 and is provided to open and close the door 15. The user presses an opening button of a control panel in the display, which is the door 15, to drive the motor 30 to allow the door 15 to perform an opened operation, or presses a closing button to drive the motor 30 to allow the door 15 to perform a closed operation.

Next, a first, second link unit 40, 50 is provided inside the housing 10, and is connected to the arm 20.

First, the first link unit 40 is provided inside the housing 10, and includes a motor link 41, a hold link 43, and a main link 45.

The motor link 41 has a first end connected to the motor 30 and a second end connected to a first end of the hold link 43. The motor link 41 is fixedly connected to the motor 30, and is connected to the hold link 43 with a rivet to be rotatable.

The motor link 41 is rotated by driving of the motor 30, and the hold link 43 connected to the motor link 41 is rotated by rotation of the motor link 41.

Next, the hold link 43 has the first end connected to the second end of the motor link 41 and a second connected to the main link 45, and connections of the hold link 43 with the motor link 41 and the main link 45 are rotatably achieved with rivets.

The hold link 43 is rotated by the motor link 41 rotated by driving of the motor 30.

Next, the main link 45 has a first end connected to the second end of the hold link 43 and a second end connected to the hinge shaft 21 of the arm 20, and connections of the main link 45 with the hold link 43 and the hinge shaft 21 are rotatably achieved with rivets.

The main link 45 is rotated by the motor link 41 and the hold link 43 that are rotated by driving of the motor 30.

Furthermore, the main link 45 has a conical shape bent upward at a predetermined angle, and the main link 45 is connected to a joint link 51, which will be described below, at the bent portion. As the conical shape of the main link 45 allows the main link 45 to be flexibly rotated when the motor link 41 and the hold link 43 are rotated by driving of the motor 30, the arm 20 is flexibly rotated, and eventually the door 15 maybe flexibly opened and closed.

Next, the second link unit 50 is provided inside the housing 10, and includes the joint link 51, an upper link 53, and a sub link 55.

The joint link 51 has a first end connected to a lower portion of the housing 10 and a second end connected to a first end of the upper link 53, and the joint link 51 is connected to the main link 45 between the first end and the second end thereof. All the connections of the joint link 51 with the housing 10, the upper link 53, and the main link 45 are rotatably achieved with rivets.

This joint link 51 is rotated by the main link 45 rotated by driving of the motor 30.

Next, the upper link 53 has the first end connected to the second end of the joint link 51 and a second end connected to the link shaft 23 of the arm 20, and connections of the upper link 53 with the joint link 51 and the link shaft 23 are rotatably achieved with rivets.

This upper link 53 is rotated by the main link 45 and the joint link 51 that are rotated by driving of the motor 30.

Next, the sub link 55 is provided inside the housing 10 and between the motor 30 and the joint link 51, and the sub link 55 has a first end connected to the lower portion of the housing 10 and a second end connected to the main link 45, and connections of the sub link 55 with the housing 10 and the main link 45 are rotatably achieved with rivets.

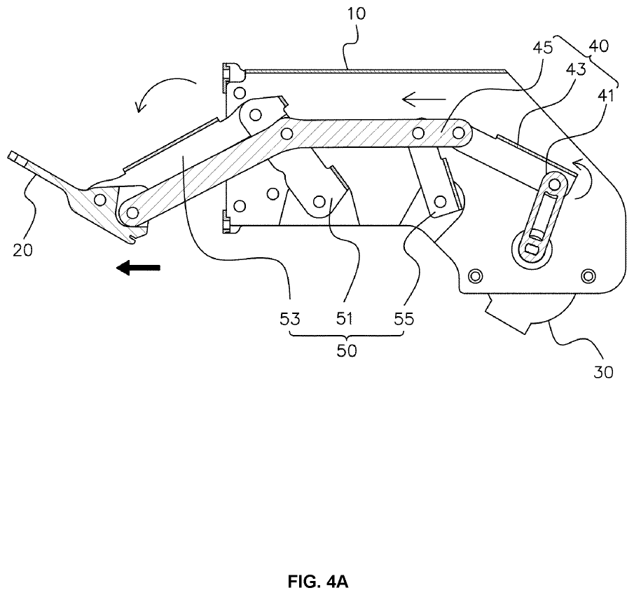

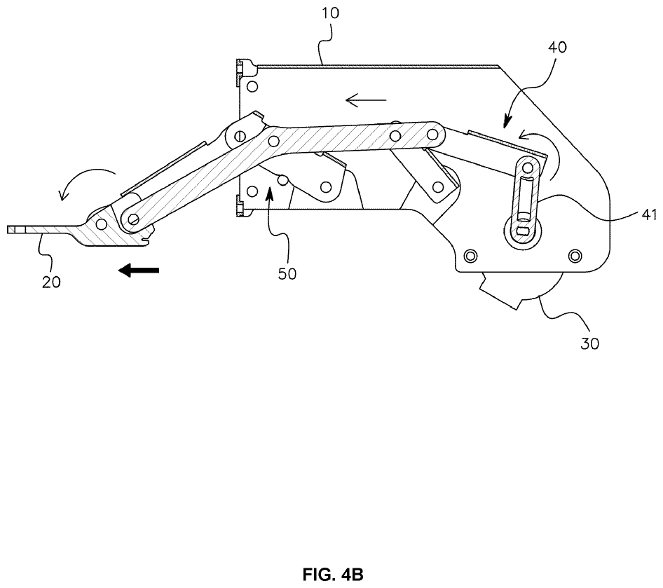

Hereinbelow, opening and closing operations of the motor-type multi-hinge 100 according to the present disclosure will be described with reference to FIGS. 4A and 4Bb. FIGS. 4A and 4B are sectional views showing operational states of the motor-type multi-hinge according to the present disclosure.

First, referring to FIG. 3A, the door is in a closed state, and the motor-type multi-hinge 100 according to the present disclosure is in a standby state. In other words, the arm 20 and the housing 10 remain at a 0 angle, and accordingly, based on the drawing, both the first and second link units 40 and 50 are rotated as far to the right as possible. The main link 45 is rotated as far to the right as possible on the hinge shaft 21, the hold link 43 is rotated as far to the right as possible on the first portion of the main link 45, the motor link 41 is rotated as far to the right as possible on the first portion of the hold link 43, and the joint link 51 and the sub link 55 are rotated as far to the right as possible on the lower portion of the housing 10.

Next, when the user touches a door open of the display, the motor 30 is driven to open the door. As shown in FIG. 4A, the motor 30 is driven, and the motor link 41 connected to the motor 30 is rotated in a direction of the arrow.

With the rotation of the motor link 41, the hold link 43 connected to the motor link 41 is rotated in a direction of the arrow, and the main link 45 connected to the hold link 43 is rotated, so that the arm 20 is rotated as shown by the arrow. At this point, FIG. 4A is a view showing a state in which the arm 20 and the housing 10 remain at an angle of 30.

In addition, as described above, as the first link unit 40 including the motor link 41, the hold link 43, and the main link 45 is rotated, the second link unit 50 is rotated. In other words, with the rotation of the main link 45, the sub link 55 connected to the main link 45 is rotated, the joint link 51 is rotated, and the upper link 53 is rotated with the rotation of the joint link 51, so that the arm 20 is rotated as shown by the arrow.

As described above, the door is not only rotated by the hinge shaft 21 but also by the link shaft 23. At this point, with the rotation through the link shaft 23, the door is rotated while being pushed in a left lower direction based on the drawing, as marked with the thick arrow.

Next, as shown in FIG. 4B, the arm 20 is brought into a state in which the arm and the housing 10 remain at an angle of 90, i.e., a state in which the door is completely opened. In other words, based on the drawing, with continuous driving of the motor 30, the first link unit 40 including the motor link 41 connected to the motor 30 is rotated in the direction of arrow, and the second link unit 50 is rotated with rotation of the first link unit 40. Accordingly, with the arm 20 marked with the thick arrow, the door is rotated while being pushed in a left lower direction.

Although the preferred embodiments of the present disclosure have been disclosed for illustrative purposes, those skilled in the art will appreciate that various modifications, additions and substitutions are possible, without departing from the scope and spirit of the invention as disclosed in the accompanying claims. Therefore, the embodiments of the present disclosure are intended to described, without limiting the technical ideas of the present disclosure, and the technical ideas of the present disclosure are not limited by the embodiments. The scope of the present disclosure will be interpreted by the accompanying claims, and those skilled in the art should understand that all technical ideas within equivalent scope should be included in the scope of the present disclosure.

What is claimed is:

1. A motor-type multi-hinge comprising:
a housing provided at a main body of a device equipped with a door;
an arm provided at the door;
a motor provided at a lower portion of the housing;
a first link unit provided inside the housing, and comprising a motor link having a first end rotatably connected to the motor, a hold link having a first end rotatably connected to a second end of the motor link, and a main link having a first end rotatably connected to a second end of the hold link and a second end rotatably connected to a hinge shaft of the arm; and
a second link unit provided inside the housing, and comprising a joint link having a first end rotatably connected to the lower portion of the housing, the joint link being rotatably connected to the main link between the first end and a second end thereof, and an upper link having a first end rotatably connected to the second end of the joint link and a second end rotatably connected to a link shaft of the arm,
wherein, when the motor is driven, the motor link is rotated and the hold link and the main link are rotated, and the joint link and the upper link are rotated by rotation of the main link, so that the arm is rotated while being pushed from the housing.

2. The motor-type multi-hinge of claim 1, wherein the second link unit further comprises a sub link provided inside the housing and between the motor and the joint link, having a first end rotatably connected to the lower portion of the housing and a second end rotatably connected to the main link.

3. The motor-type multi-hinge of claim 2, wherein the main link has a shape bent upward at a predetermined angle, and the main link is connected to the joint link at the bent portion.
